(19) United States
(12) Patent Application Publication
(10) Pub. No.: US 2008/0311997 A1
(43) Pub. Date: Dec. 18, 2008

(54) DATA CAPTURE FOR INTERACTIVE OPERATION

(75) Inventors: Andrew Goossen, Issaquah, WA (US); Matthew Bronder, Bellevue, WA (US); John Howard Palevich, Medina, WA (US); Richard Moore, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/763,715

(22) Filed: Jun. 15, 2007

(51) Int. Cl. A63F 9/24; H04N 9/79

(52) U.S. Cl. 463/43; 386/40

(57) ABSTRACT

A console is adapted to capture audio, video and other associated data to be rendered on a display during operation of an interactive media file. Captured data can be stored in a buffer so that selectable portions thereof can be persisted and/or transmitted as a media file.

### BACKGROUND

Multimedia consoles such as video game consoles are interactive entertainment devices used for playing gaming titles. In some instances, users operating these consoles wish to record or capture data of a particular title during operation. One current approach for capturing this data utilizes an external video camera positioned in front of a display to record what is being displayed on the display as well as audio associated therewith. This approach involves planning and time to set up the video camera and record the data. Furthermore, transferring the captured data to another device or the Internet can be time consuming.

In another approach, the game title captures game simulation data based on user data input. This captured data can be used to replay audio and video data based on game logic executing simulation of the captured data. This logic is game specific and requires operation of the game title to replay audio and video.

The discussion above is merely provided for general background information and is not intended to be used as an aid in determining the scope of the claimed subject matter.

### SUMMARY

A console is adapted to capture audio, video and other associated data to be rendered on a display during operation of an interactive gaming title. Captured data can be stored in a buffer so that selectable portions thereof can be persisted and/or transferred as a media file.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is an isometric view of an exemplary view gaming and media system.

FIG. 2 is an exemplary functional block diagram of components of the gaming and media system shown in FIG. 1.

FIG. 3 is a block diagram of an interactive environment for a gaming and media system.

FIG. 4 is a block diagram of components for capturing audio, video and other data during an interactive operation.

FIG. 5 is a flow diagram of a method for capturing data from an interactive operation.

FIG. 6 is a flow diagram of a method for capturing video data from an interactive operation.

FIG. 7 is a flow diagram of a method for capturing audio data from an interactive operation.

FIG. 8 is a flow diagram of a method for capturing metadata from an interactive operation.

FIG. 9 is a flow diagram of a method for processing captured data in a guide interface from an interactive operation.

FIG. 10 is a method for compressing captured data from an interactive operation.

### DETAILED DESCRIPTION

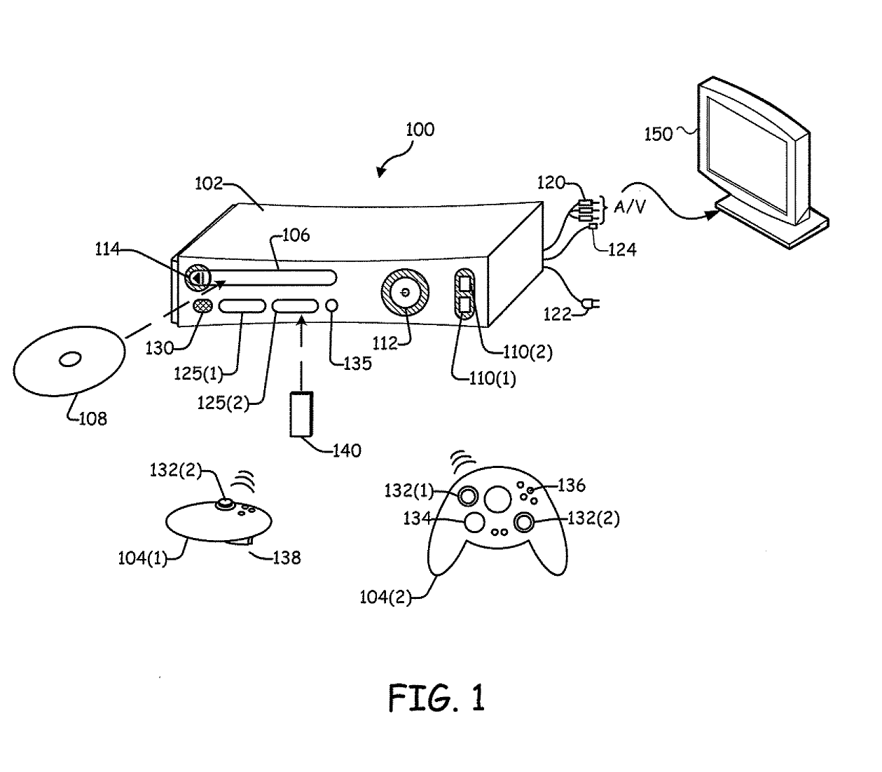

FIG. 1 shows an exemplary gaming and media system 100. The following discussion of FIG. 1 is intended to provide a brief, general description of a suitable environment in which concepts presented herein may be implemented. As shown in FIG. 1, gaming and media system 100 includes a game and media console (hereinafter “console”) 102. In general, console 102 is one type of computing system, as will be further described below. Console 102 is configured to accommodate one or more wireless controllers, as represented by controllers 104(1) and 104(2). Console 102 is equipped with an internal hard disk drive (not shown) and a portable media drive 106 that supports various forms of portable storage media, as represented by optical storage disc 108. Examples of suitable portable storage media include DVD, CD-ROM, game discs, and so forth. Console 102 also includes two memory unit card receptacles 125(1) and 125(2), for receiving removable flash-type memory units 140. A command button 135 on console 102 enables and disables wireless peripheral support.

As depicted in FIG. 1, console 102 also includes an optical port 130 for communicating wirelessly with one or more devices and two USB (Universal Serial Bus) ports 110(1) and 110(2) to support a wired connection for additional controllers, or other peripherals. In some implementations, the number and arrangement of additional ports may be modified. A power button 112 and an eject button 114 are also positioned on the front face of game console 102. Power button 112 is selected to apply power to the game console, and can also provide access to other features and controls, and eject button 114 alternately opens and closes the tray of a portable media drive 106 to enable insertion and extraction of a storage disc 108.

Console 102 connects to a television or other display (not shown) via A/V interfacing cables 120. In one implementation, console 102 is equipped with a dedicated A/V port (not shown) configured for content-secured digital communication using A/V cables 120 (e.g., A/V cables suitable for coupling to a High Definition Multimedia Interface “HDMI” port on a high definition monitor 150 or other display device). A power cable 122 provides power to the game console. Console 102 may be farther configured with broadband capabilities, as represented by a cable or modem connector 124 to facilitate access to a network, such as the Internet. The broadband capabilities can also be provided wirelessly, through a broadband network such as a wireless fidelity (Wi-Fi) network.

Each controller 104 is coupled to console 102 via a wired or wireless interface. In the illustrated implementation, the controllers are USB-compatible and are coupled to console 102 via a wireless or USB port 110. Console 102 may be equipped with any of a wide variety of user interaction mechanisms. In an example illustrated in FIG. 1, each controller 104 is equipped with two thumbsticks 132(1) and 132(2), a D-pad 134, buttons 136, and two triggers 138. These controllers are merely representative, and other known gaming controllers may be substituted for, or added to, those shown in FIG. 1.

In one implementation (not shown), a memory unit (MU) 140 may also be inserted into console 100 to provide additional and portable storage. Portable MUs enable users to store game parameters for use when playing on other consoles. In this implementation, each controller is configured to accommodate two MUs 140, although more or less than two MUs may also be employed.

Gaming and media system 100 is generally configured for playing games stored on a memory medium, as well as for downloading and playing games, and reproducing pre-recorded music and videos, from both electronic and hard media sources. With the different storage offerings, titles can be played from the hard disk drive, from optical disk media (e.g., 108), from an online source, or from MU 140. A sample of the types of media that gaming and media system 100 is capable of playing include:

Game titles played from CD and DVD discs, from the hard disk drive, or from an online source.

Digital music played from a CD in portable media drive 106, from a file on the hard disk drive (e.g., music in the Windows Media Audio (WMA) format), or from online streaming sources.

Digital audio/video played from a DVD disc in portable media drive 106, from a file on the hard disk drive (e.g., Active Streaming Format), or from online streaming sources.

During operation, console 102 is configured to receive input from controllers 104 and display information on a display. For example, console 102 can display a user interface on the display to allow a user to operate and interact with an interactive computing operation such as a game title. The game title produces audio data that can be played on speakers (e.g. on the display or external thereto) and video data that can be displayed on the display (e.g. as a sequence of images). Capture of A/V data to be sent to the display can be enabled by functional components within console 102. This captured data can be used for A/V data playback and/or transferred to a suitable media file that can easily be shared across a number of different computing devices.

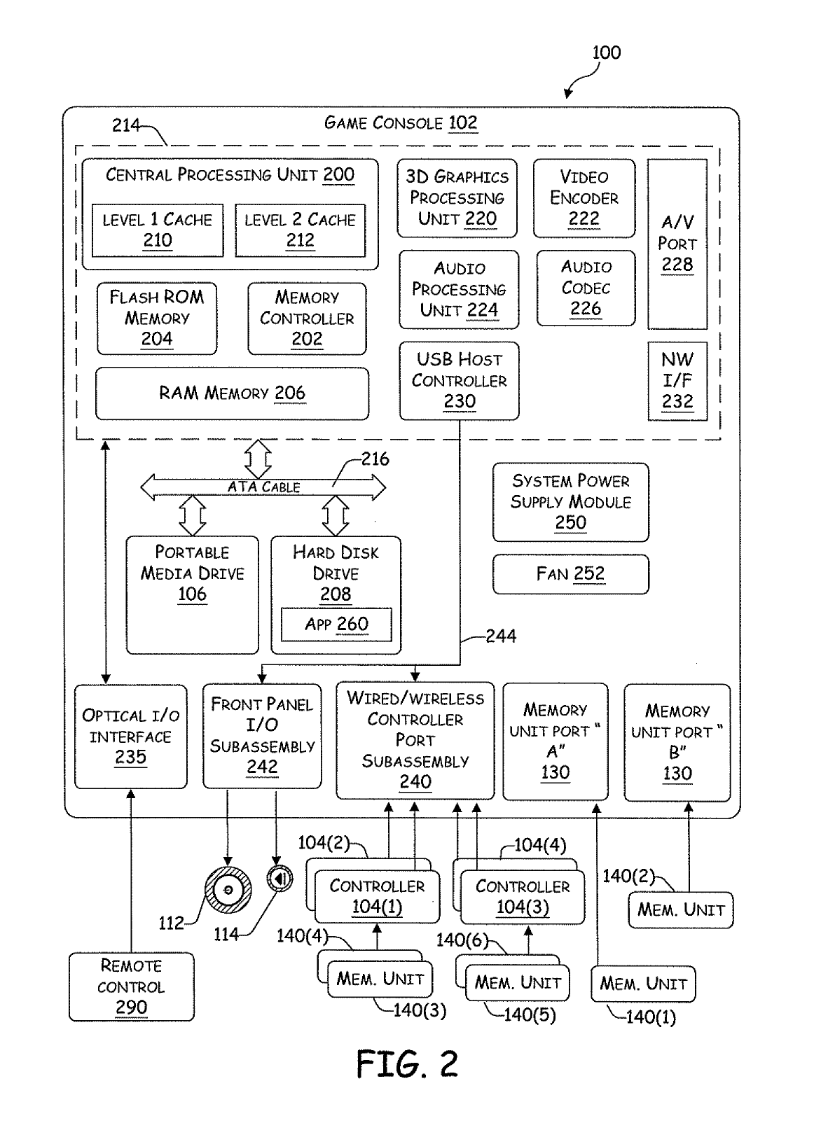

FIG. 2 is a functional block diagram of gaming and media system 100 and shows functional components of gaming and media system 100 in more detail. Console 102 has a central processing unit (CPU 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210, and a level 2 cache 212 to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a Peripheral Component Interconnect (PCI) bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller via the PCI bus and an AT Attachment (ATA) bus 216. However, in other implementations, dedicated data bus structures of different types can also be applied in the alternative.

A three-dimensional graphics processing unit (GPU) 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214. Data produced during an interactive operation that is to be sent to A/V port 228 can be captured for future playback and/or transferred to a media file.

FIG. 2 shows module 214 including a USB host controller 230 and a network interface 232. USB host controller 230 is shown in communication with CPU 200 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 2, console 102 includes a controller support subassembly 240 for supporting four controllers 104(1)-104(4). The controller support subassembly 240 includes any hardware and software components needed to support wired and wireless operation with an external control device, such as for example, a media and game controller. A front panel I/O subassembly 242 supports the multiple functionalities of power button 112, the eject button 114, as well as any LEDs (light emitting diodes) or other indicators exposed on the outer surface of console 102. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

MUs 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202.

A system power supply module 250 provides power to the components of gaming system 100. A fan 252 cools the circuitry within console 102. An application 260 comprising machine instructions is stored on hard disk drive 208. When console 102 is powered on, various portions of application 260 are loaded into RAM 206, and/or caches 210 and 212, for execution on CPU 200, wherein application 260 is one such example. Various applications can be stored on hard disk drive 208 for execution on CPU 200.

Gaming and media system 100 may be operated as a standalone system by simply connecting the system to monitor 150 (FIG. 1), a television, a video projector, or other display device. In this standalone mode, gaming and media system 100 enables one or more players to play games, or enjoy digital media, e.g., by watching movies, or listening to music. However, with the integration of broadband connectivity made available through network interface 232, gaming and media system 100 may further be operated as a participant in a larger network gaming community. Network interface 232 can be used to transfer media files of captured data of an interactive operation.

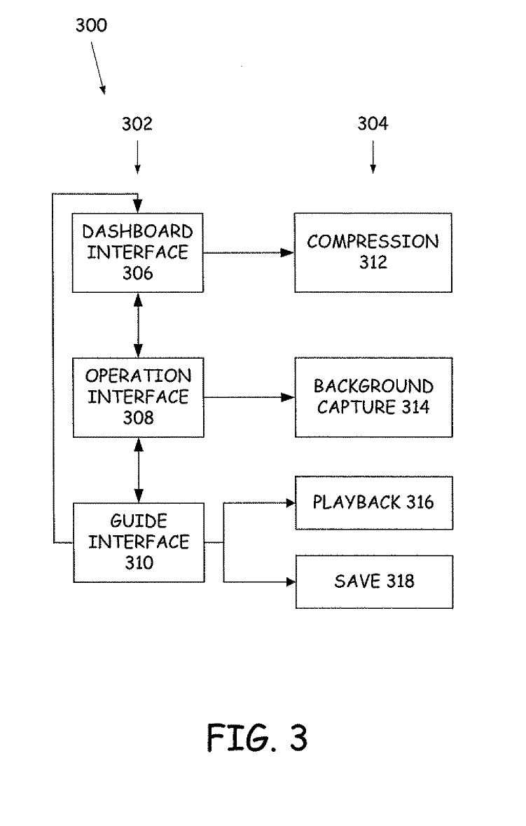

FIG. 3 is a block diagram of an interactive environment 300 implemented by system 100 that includes a plurality of interface modes 302 and a plurality of processing modes 304. The user can operate and interact with any of the plurality of interface modes 302 as desired. During interaction with the interface modes 302, each of the processing modes 304 can be selectively enabled/disabled depending upon the current interface mode. The interface modes 302 include a dashboard interface 306, an operation interface 308 and a guide interface 310. The processing modes 304 include a compression process 312, a background capture process 314, a playback process 316 and a save process 318. Within the interface modes, allocation of components of system 100, such as CPU 200 and GPU 220, can be adjusted according to predetermined specifications depending on a particular task being performed by system 100. For example, a significant percentage of CPU 200 and GPU 220 can be allocated to a game title during gaming operations to allow game developers to better utilize components in system 100. A smaller percentage can be reserved by system 100 for performing other tasks.

Dashboard interface 306 is utilized as an interface for system 100. While in dashboard interface 306, a user can select from a plurality of interactive operations. For example, a user can select a particular game title to play. Additionally, dashboard interface 306 can also be used to perform other tasks such as managing files, user information, network connections, etc. In some implementations of system 100, dashboard interface 306 is allocated a larger amount of capacity for the CPU 200 of system 100 than during operation interface 308 or guide interface 310. Additionally, rendering of dashboard interface 306 is independent of particular interactive operations such as games and operates independently from operation interface 308 and guide interface 310. Since capacity of CPU 200 is allocated in this manner, compression process 312, which can consume a large amount of capacity of CPU 200, can be enabled to compress files captured and saved by background capture process 314 and save process 318, respectively. The resulting compressed files can be shared, for example, using network interface 232.

Operation interface 308 is launched upon selection of a title such as a game title from dashboard interface 306. In addition, operation interface 308 can be launched by loading a game title into drive 106 or by powering system 100. In operation interface 308, the user interacts with the particular title selected to produce audio and video data in response to commands from the user. During operation interface 308, a significant percentage of resources, for example CPU 200 and GPU 220, can be allocated to a game title such that the gaming operation can perform under more preferable conditions with more capacity. The data produced during interaction can include a plurality of video frames provided at a specified rate and with a particular resolution as well as audio data associated with each frame. The interaction in operation interface can be various forms of interaction including playing a particular game, singing a particular karaoke song, etc.

While operating the particular title, background capture process 314 is enabled to capture A/V data for future manipulation. For example, background capture process 314 can capture football plays in a football video game or tactical maneuvers in a role playing game. If desired, the user or game title can selectively disable background capture process 314 using an application program interface. Background capture process 314 can be designed to capture A/V data without significant impact to the functional components of system 100 or to video displayed on a display in response to the user's commands. The capture can be implemented with limited effect to resources allocated to the game title. Thus, the user will be able to play a game as is normally perceived and can retroactively decide whether or not to save captured data to a more permanent file.

From interactive operation interface 308, the user can choose to transfer to guide interface 310. For instance, the user may press a “pause” button that will immediately launch guide interface 310. While in guide interface 310, background capture process 314 can be selectively suspended. Alternatively, background capture process 314 can continue in guide interface 310. At this point, the user can initiate playback process 316 and/or save process 318. Playback process 316 allows a user to view A/V data captured by background capture process 314. The A/V data can be marked with certain event tags that are pertinent to a particular game. For example, a user interface could be provided showing screen shots of the last ten plays of a current football game. These plays can be selected for viewing using playback process 316. Other events can be marked as desired to provide the user with an easier interface for viewing the captured data.

Save process 318 can be used by the user to indicate portions of the background capture process 314 data to be saved (e.g. persisted) in a more permanent file. Persisted data refers to a characteristic of data that exists beyond execution of an operation that creates the data. The indicated data can include any portion of the captured data such as an event, a specified time period, a single video frame, etc. The indicated data is marked for further compression and transfer to a more permanent file in memory. After exiting interactive operation interface 308 and/or guide interface 310, the interface returns to dashboard interface 306. Based on the selected data provided in save process 318, compression process 312 is initiated to compress and save data to a more permanent file. This compressed data can be used to send across a network such as the Internet to be shared with other users. For example, videos captured from background capture process 314 can be used for promotion of a particular game, show other users special events from a game, or other uses.

It is worth noting that environment 300 is illustrative only, and several of the interfaces and processes can be adjusted as desired. For example, dashboard interface 308 can also be adapted to initiate playback process 316 and save process 318. Additionally, operation interface 308 and/or guide interface 310 can be adapted to initiate compression process 312. In this manner, a user can save and/or transmit media files to other users through a network. Furthermore, dashboard interface 306 and guide interface 310 could be merged into a single interface such that environment 300 could operate in dashboard interface 306 and implement one or more of the compression process 312, playback process 316 and save process 318.

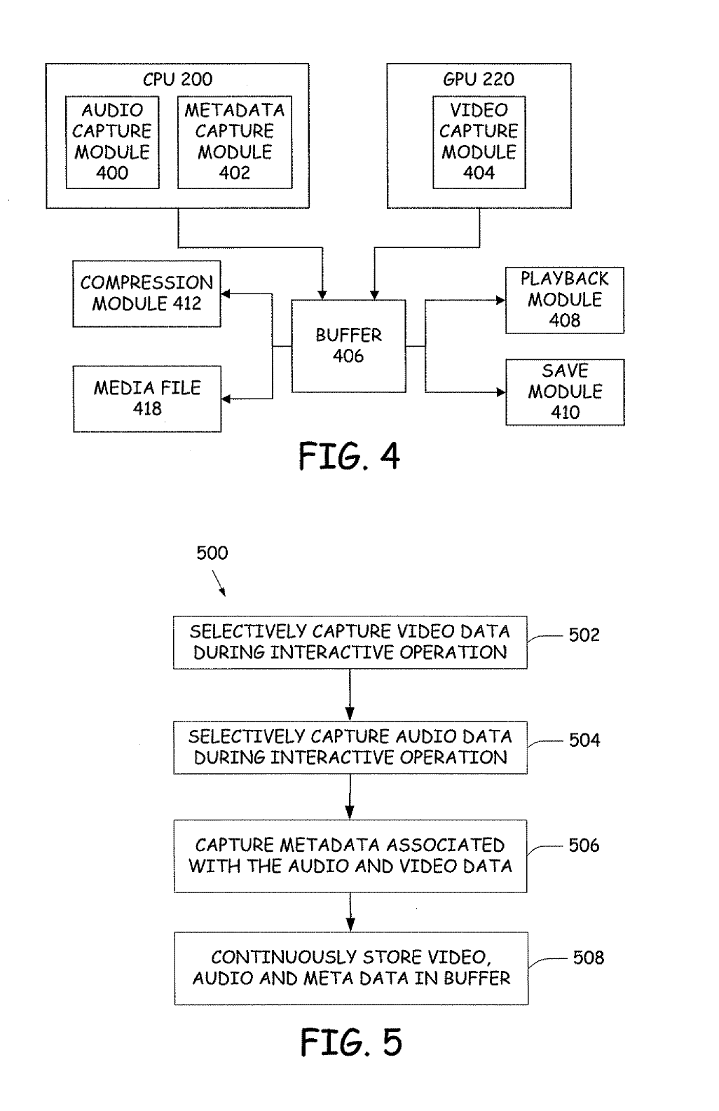

FIG. 4 is a block diagram of components utilized in background capture process 314. CPU 200 includes an audio capture module 400 and a metadata capture module 402 to capture audio data and metadata, respectively, during operation of an interactive title while in operation interface 308. Additionally, graphics processing unit 220 includes a video capture module 404 that captures video data during operation of an interactive title. In order to reduce impact on CPU 200 and/or GPU 220, audio capture module 400 is adapted to selectively capture audio data processed by CPU 200. Similarly, video capture module 404 is adapted to selectively capture video data processed by GPU 220. In addition, other processing techniques can be utilized to reduce impact and prevent overload of processing on CPU 200 and GPU 220 during an interactive operation.

Audio data from audio capture module 400, metadata from metadata capture module 402 and video data from video capture module 404 are sent to a buffer 406. Association of audio data with its corresponding video data is maintained in buffer 406. Thus, when replayed, captured audio data is synchronized with its associated video data. In one embodiment, buffer 406 is a circular buffer that is a permanently allocated portion of memory including a read position and a write position. The circular buffer operates in a first-in, first-out (FIFO) manner. In order to implement continuous capture of game play A/V data, it can make sense to limit the size of buffer 406. For example, buffer 406 can be of sufficient size to capture two minutes, five minutes, ten minutes, twenty minutes, one hour or other duration to limit the need for available buffer space to implement A/V data capture. Furthermore, CPU 200 and GPU 220 can be equipped with direct memory access to buffer 406, which can be a more efficient approach to data transfer to buffer 406. Buffer 406 can include any memory component, for example level one cache 210, level two cache 212, RAM memory 206, hard disk drive 208 and/or memory units otherwise accessible by system 100. If buffer is implemented in hard disk drive 208, it can be beneficial to keep captured data defragmented as well as close to an outer edge of the disk to reduce processing time during capture.

Buffer 406 has access to a playback module 408, a save module 410 and a compression module 412 that implement playback process 316, save process 318 and compression process 312, respectively. Utilizing these processes, a media file 418 can be more permanently stored (e.g. persisted) in a format that is accessible by a plurality of computing devices. Example formats include Windows Media Video (WMV), Advanced System Format (ASF), Moving Picture Exports Group (MPEG), etc. Playback module 408 can display data captured in buffer 406 while in guide interface 310. Save module 410 identifies data in buffer 406 that should not be overwritten and eventually compressed when in dashboard interface 306. Compression module 412 is initialized to compress data in buffer 406 to a media file 418.

FIG. 5 is a flow diagram of a method 500 performed by background capture process 314 during an interactive operation that produces A/V data in response to a user's input. The method 500 can be performed while the user interfaces with operation interface 308 and can be performed independent of the user's input such that the user may retroactively choose to save captured data to a more permanent file. Additionally, method 500 can be performed independent of operation of a game title such that game developers need not spend considerable time and expense in implementing a game specific capture process such that clips of games can be captured and persisted to standardized media files. The A/V data captured can be of a different format from what is displayed on a display and captured while the user interacts with the game. Method 500 includes step 502, wherein video data is selectively captured by video capture module 404. In one embodiment, video capture module 404 is a shader, which is a set of instructions that process video data within graphics processing unit 220. The shader only uses a small portion of capacity for the graphics processing unit 220 to prevent significant impact on GPU 220.

At step 504, audio data is selectively captured. Audio data is captured by audio capture module 400. The audio data can include data produced by an interactive title and/or sounds external to the interactive title such as the voice of the user through a headset. In addition, at step 506, metadata associated with the audio and video data is captured. This metadata can include a game title, song title, level within a game, user information, etc. The metadata can also include input provided by a user. For example, the metadata can include when particular buttons were pressed by a user during a gaming operation. The button input is provided with a time value that corresponds to the time that the button was pressed with respect to the captured audio and/or video data. Thus, a user can record video and associated buttons for the purpose of showing other users tips within a game. At step 508, video, audio and metadata are continuously stored in buffer 406. The storage can be based on a buffer size wherein alignment of the video and audio data is maintained. If a user chooses to save a particular portion of the captured data, the buffer size can be reduced to prevent the portion from being overwritten in buffer 406. If a circular buffer is used for buffer 406, separate read and write positions are used to read and write to and from the buffer 406.

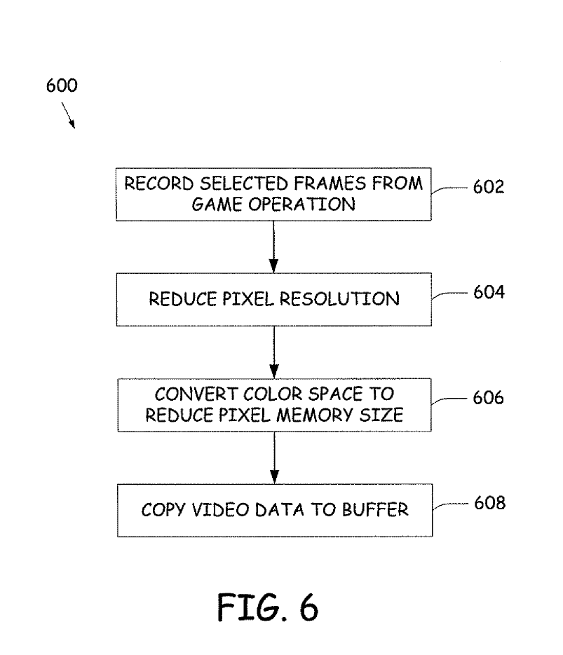

FIG. 6 is a flow diagram of a method 600 for capturing video data during background capture process 314. At step 602, selected frames of video data are recorded during an interactive operation. The selected frames include raw video data from a frame buffer in system 100. Video capture module 404 can selectively capture all frames of video data produced during the operation or a portion thereof. The capture can be performed as a function of a rate that the video is produced. For example, if a game produces video data at a rate of 60 frames per second, video capture module 404 can be configured to capture every second frame of the video data rather than every frame. Thus, for a video data segment that is one second in duration, 30 frames would be captured. Although capturing less than all frames of video data can reduce resolution of the video data, it can be easier for GPU 220 to capture a portion of the video data such that transfer of video meant for display 150 is not significantly impacted. If a game produces 30 frames of video per second, video capture module can be adapted to capture all frames of the video data.

In addition to capturing only selected frames, portions of the frames themselves can be ignored as well as compressing the video frames. At step 604, pixel resolution can be compressed (or reduced) to limit the overall resources utilized by GPU 220. For example, if GPU 220 sends video frames with 1280 pixels by 720 pixels, this frame can be condensed to a lesser number of pixels for a frame such as 400 pixels by 224 pixels. In one embodiment, this reduction is performed by capturing a central portion of each frame (e.g., the center 1200 pixels by 672 pixels). Then, the central frame portion can be scaled by an integer scale factor (e.g., a scale factor of 3 yields a 400 pixel by 224 pixel frame). The reduction can be performed by a suitable filter such as a box filter or Gaussian filter. Thus, video capture module can perform frame compression as a function of the number of pixels provided in a given frame. If less pixels are used for a frame, less compression can be used (e.g. by a scale factor of 2). If more pixels are used for a frame, more compression can be used (e.g. by a scale factor of 4 or 5).

At step 606, the color space of the selected video frames are converted to reduce the pixel memory size. Each pixel is associated with a particular color, wherein each color in the color space can be denoted by a unique value. By reducing the color space, the number of unique values representing individual colors can be reduced thus reducing the overall size of captured data. At step 608, the resulting video data is copied to the buffer 406. Method 600 is illustrative only and several techniques for capture can be utilized such as block-based compression, inter-frame compression, entropy encoding, etc.

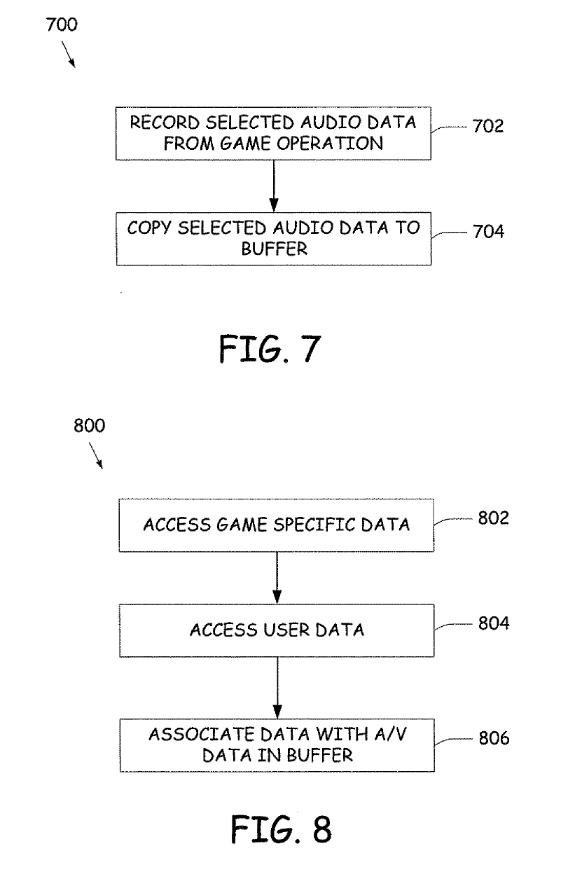

FIG. 7 is a flow diagram of a method 700 for capturing audio data using audio capture module 400. At step 702, selected audio data is recorded from the interactive operation. The audio data captured can include all raw audio data produced by the interactive operation or a portion thereof For example, if a game title produces six channels of audio data, audio capture module 400 can capture less channels, for example two channels. In one example, a subwoofer channel can be ignored and a remaining 5 channels can be mathematically combined to form two channels. Additionally, the selected audio data that is captured can include other audio data such as voice capture of a user's voice if the user is using a headset during, for example, a multi-player game. This audio data can be provided in a separate stream to buffer 406. At step 704, the selected audio data is copied to the buffer.

FIG. 8 is a flow diagram of a method 800 for capturing metadata. Metadata can be any additional contextual data that is not provided as video data or audio during operation of a title. Method 800 begins at step 802, wherein game specific data is accessed. At step 804, gamer data for the user operating the interactive title is accessed at step 804. In step 806, the A/V data in the buffer is associated with the accessed metadata. This metadata can be associated with the A/V data for forming tags that can be used for categorizing, searching and processing of the A/V data. For example, the metadata can indicate a user, a game, a level, etc.

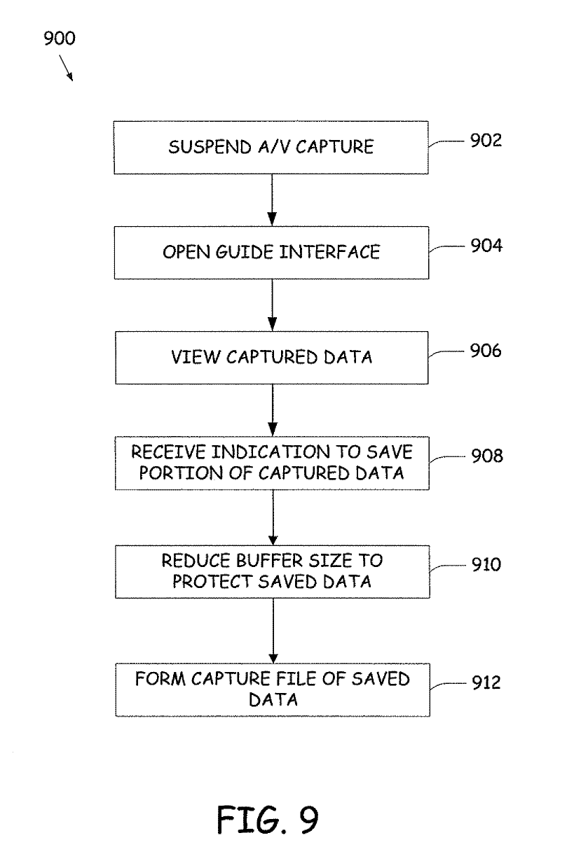

FIG. 9 is a flow diagram of a method 900 for saving A/V data that has been captured. When a user has selected to change from operation interface 308 to guide interface 310, the A/V capture provided in background A/V capture process 314 is suspended at step 902. Additionally, at step 904, the guide interface 310 is opened for interaction with the user. The guide interface 310 provides several options for a user such as changing game parameters, viewing captured data and saving captured data. If desired, the user can view the captured data at step 906. The captured data can be presented in specified subsets for easy navigation and selection of content to be saved. Otherwise, or in addition to, the user can indicate to save a portion of the captured A/V data at step 908 such as the last two minutes, the last event, etc. At step 910, the buffer size is reduced to not overwrite the saved data. If a circular buffer is used, the write position can be updated to prevent overwrite. At step 912, a captured file of the indicated to be saved data is formed for later compression.

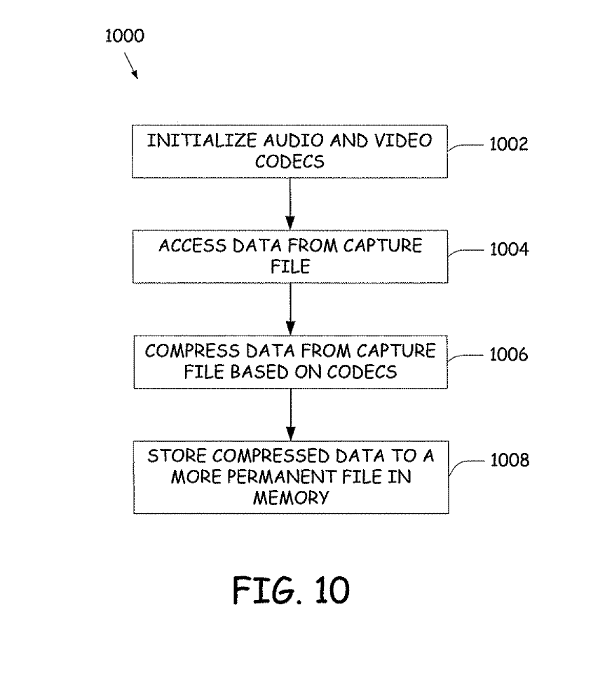

FIG. 10 is a method for compressing a captured A/V file. At step 1002, audio and/or video codecs are initialized. These codecs can include any particular codec for processing audio and/or video data. At step 1004, data from the captured file formed in step 912 is accessed. Next, at step 1006, the data is from the captured files compressed based on the codecs. If desired, additional data can be compressed along with the capture file such as adding external voice data and/or background music, for example. In step 1008, the compressed data is written to a more permanent file in memory. At this point, the file can be written to a portion of disk drive 208. If desired, the media file can be transferred or otherwise shared with other computing devices through network interface 232.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of operating a computing device, comprising:
performing an interactive operation that produces video data for display in response to commands received from a user;
capturing the video data for storage in a buffer during the interactive operation; and
allowing the user to selectively persist the video data to a media file after capture.

2. The method of claim 1 wherein capturing the video data comprises capturing a selected number of frames for a video data segment that is less than all frames for the segment.

3. The method of claim 1 wherein capturing the video data further comprises compressing a number of pixels for the captured video data before storage in the buffer, selecting a number of frames for capture as a function of producing the video data and capturing an amount of video data as a function of a number of pixels in a frame of the video data.

4. The method of claim 1 and further comprising:
receiving an indication from the user to display the captured video data; and
displaying the captured video data on a display device.

5. The method of claim 1 and further comprising:
receiving an indication from the user to save captured video data in the buffer;
marking the indicated data in the buffer; and
altering the buffer to prevent the indicated data from being overwritten.

6. The method of claim 1 wherein capturing the video data is performed independent of production of the video data within the interactive operation.

7. The method of claim 1 and further comprising:
receiving an indication from the user to display a portion of the captured video data; and
displaying the indicated portion of the captured video data.

8. The method of claim 1 and further comprising:
receiving an indication to save a portion of the captured video data; and
forming a capture file of the indicated portion.

9. The method of claim 8 and further comprising:
exiting the interactive operation to provide an interface independent of the interactive operation; and
compressing the captured video data to a format different from the capture file.

10. The method of claim 1 and further comprising capturing metadata in the buffer associated with the interactive operation and the video data.

11. A gaming console, comprising:
a buffer;
a port adapted to be coupled to a display;
a game controller interface receiving commands from a game controller;
a central processing unit operating a game in response to the commands received from the game controller to produce information indicative of video data for the game;
a graphics processing unit coupled to the central processing unit to form the video data and transfer the video data for the game to the port; and
a video capture module coupled to the graphics processing unit and adapted to capture the video data to store in the buffer during operation of the game.

12. The console of claim 11 wherein the video capture module is adapted to capture a selected number of frames for a video data segment for the game that is less than all frames for the segment.

13. The console of claim 11 wherein the video capture module is adapted to compress a number of pixels for the video data before storage in the buffer, select a number of frames for capture as a function of a rate of producing the video data, and capture an amount of video data as a function of a number of pixels in each frame.

14. The console of claim 11 and further comprising:
an audio capture module coupled to the central processing unit and adapted to capture audio data in the buffer produced by the interactive operation.

15. The console of claim 11 and further comprising:
a metadata capture module coupled to the central processing unit and adapted to capture metadata associated with the game.

16. The console of claim 1 and further comprising:
a playback module adapted to receive an indication to display a portion of captured video data and send the portion of captured video data to the port; and
a save module adapted to receive an indication to save a portion of the captured video data and form a capture file of the indicated portion.

17. The console of claim 16 and further comprising:
a compression module adapted to compress the captured video data to a format different from the capture file while in a mode independent of operation of the game.

18. A method of processing data in a gaming console, comprising:
producing audio and video data for a game in response to input from a user;
capturing the audio data to a buffer during operation of the game;
capturing the video data to the buffer during operation of the game as a function of size and rate of the video data;
compressing the audio data and the video data to a media file in memory within the gaming console as a function of user input.

19. The method of claim 18 and further comprising:
capturing less audio data than is produced for the game into the buffer;
selecting a number of frames of the video data to be captured as a function of rate of the video data;
reducing a number of pixels for the selected number of frames as a function of size of the video data;
replaying the captured audio and video data during suspension of the game; and
receiving an indication to store a portion of the captured audio and video data to form the media file.

20. The method of claim 18 and further comprising:
operating instructions for the game independent of capturing the audio data and video data independently of producing the audio and video data.
